(19) United States
(12) Patent Application Publication
(10) Pub. No.: US 2026/0285195 A1
(43) Pub. Date: Sep. 24, 2026

(54) ENERGY STORAGE SYSTEM, METHOD FOR OPERATING AN ENERGY STORAGE SYSTEM, AND USE OF AN ENERGY STORAGE SYSTEM

(71) Applicant: Schaeffler Technologies AG & Co. KG, Herzogenaurach (DE)

(72) Inventor: Paul-Markus Schweizer-Berberich, Berlin (DE)

(73) Assignee: Schaeffler Technologies AG & Co. KG, Herzogenaurach (DE)

(21) Appl. No.: 19/118,762

(22) PCT Filed: Sep. 26, 2023
(86) PCT No.: PCT/EP2023/076464

§ 371 Date: Apr. 30, 2025

(30) Foreign Application Priority Data
Oct. 6, 2022 (DE) 10 2022 210 572.9

(51) Int. Cl. B60L 50/64; H01G 11/10; H01G 11/74; H01M 10/42; H01M 10/46; H01M 50/204; H01M 50/249

(52) U.S. Cl. CPC B60L 50/64; H01G 11/10; H01G 11/74; H01M 10/425; H01M 10/46; H01M 50/204; H01M 50/249; H01M 2220/20

(57) ABSTRACT

An energy storage system, having an electrical energy storage device having a first storage unit consisting of high-power cells and a second storage unit consisting of high-energy cells. The system furthermore has: an energy transfer unit in order to enable energy to be transferred between the first storage unit and the second storage unit; a connection device intended to charge and discharge the electrical energy storage device; a recording device for recording operating parameters of the electrical energy storage device, including at least one state parameter of the high-power cells and one state parameter of the high-energy cells; and a control device for controlling the energy transfer unit in accordance with a transfer algorithm that makes provision to control the energy transfer unit in accordance with a transfer strategy as a function of the recorded operating parameters.

### CROSS-REFERENCE TO RELATED APPLICATIONS

This application claims priority to PCT Application PCT/EP2023/076464, filed Sep. 26, 2023, which claims priority to German Patent Application No. DE 10 2022 210 572.9, filed Oct. 6, 2022. The disclosures of the above applications are incorporated herein by reference.

### FIELD OF THE INVENTION

The present invention relates to an energy storage system, to a method for operating an energy storage system and to the use of an energy storage system.

The field of the invention relates to the storage of energy. This plays a central role for example in connection with obtaining electrical energy from renewable energy sources such as photovoltaics, hydropower, wind power, etc., in order to enable demand-oriented provision of energy regardless of the time it is obtained. Moreover, the storage of energy plays a central role for example in the automotive sector in supplying energy to an electric drive system of a vehicle, such as for example a battery electric vehicle (BEV) or a hybrid electric vehicle (HEV).

### BACKGROUND OF THE INVENTION

In the abovementioned applications, use is typically made of electrical energy storage devices in which the energy is stored in a plurality of rechargeable battery cells interconnected in parallel and/or in series. A series interconnection of battery cells (or of multiple battery cells interconnected in parallel) in this case advantageously makes it possible to implement the energy storage device (rechargeable battery) with a voltage at an electrical connection of the energy storage device that may be selected to be multiple times greater than the voltage of the individual battery cells. In contrast thereto, a parallel interconnection of battery cells (or of multiple battery cells interconnected in series) makes it possible to increase both the storage capacity (with regard to energy or electric charge) and the “load capacity” of the energy storage device with regard to a maximum electric power or a maximum electric current during charging or discharging of the energy storage device.

One problem when designing battery cells and storage units formed thereby is that a higher energy density is generally accompanied by lower power density and, vice versa, a higher power density is accompanied by lower energy density. Based on this conflict of objectives, battery cells may often be classified as a “high-energy cell” (HEC) or as a “high-power cell” (HPC), depending on which of the two conflicting parameters, that is to say storage capacity or energy density (in the case of HEC), on the one hand, and load capacity or power density (in the case of HPC), on the other hand, is able to be considered to be comparatively good compared to other types of battery cells.

High-energy cells (HEC) are typically used to supply energy in a battery electric vehicle (BEV) in order to achieve a long range, whereas high-power cells (HPC) are often more advantageous for use in a hybrid electric vehicle (HEV), for example in order to be able to store electrical energy with a high power during recuperation.

The respective other physical parameter of the pair “storage capacity” and “load capacity” in this case has to be fulfilled as well by the electrical energy storage device, which in practice may have the disadvantageous result that a number of HECs that is unnecessarily large per se have to be installed in order to achieve a desired load capacity or, conversely, a number of HPCs that is unnecessarily large per se have to be installed in order to achieve a desired storage capacity.

Compromises are also often made, for instance by choosing a design of the battery cells in which the parameters of load capacity and storage capacity are both located “in a middle range”. However, such cells are also not battery cells that are best suited for most applications (since they have neither a high load capacity nor a high storage capacity).

It should be noted in this context that, for example in BEV applications, the load capacity (performance) of the electrical energy storage device is relevant not only with regard to a required or desired electric power when the electric drive system is supplied with current, that is to say during discharging of the energy storage device, but also with regard to the time required to (partially or fully) charge the energy storage device, that is to say charging times or fast-charging capability. Fast-charging capability is limited in high-energy cells (HEC). A design with high-power cells (HPC) would overcome this limitation, but would, as a trade-off, significantly reduce the maximum energy content of the energy storage device at its specified weight or volume, and thus the range of the vehicle.

It should also be noted in this context that load capacity (performance) may in practice need to be defined separately for the discharging and charging of the energy storage device (battery) for a specific application scenario in the sense of a maximum permissible electric power during operation, it having to be taken into account that the ageing or degeneration of battery cells and thus of the energy storage device is often correlated with high currents or powers during discharging and/or charging. In this respect, a further conflict of objectives exists in that a higher permissible electric power is generally accompanied by a shorter service life and/or poorer cycle stability and, vice versa, a longer service life and/or greater cycle stability is accompanied by a lower electrical load capacity. Cycle stability indicates how often a battery is able to be discharged and then recharged until its storage capacity falls below a certain value. In this respect too, it is thus necessary to make a compromise when designing the energy storage device.

One approach known in principle from the prior art for solving the problems with electrical energy storage devices outlined above consists in using both high-energy cells (HEC) and high-power cells (HPC) in an electrical energy storage device in accordance with a “hybrid storage concept” in order, by combining these different types of battery cells, to combine their respective positive energy and power characteristics.

An energy storage system of this type (hybrid storage concept), which also forms the technical starting point of the present invention, is known for example from publication DE 10 2012 110 030 A1 and has an electrical energy storage device having a first storage unit consisting of high-energy cells (HEC) and a second storage unit consisting of high-power cells (HPC). The two storage units are normally connected in parallel via a controllable switch during charging or discharging of the energy storage device. This switch may be opened, for example, in order to be able to charge or discharge only one of the two storage units on a targeted basis. For this purpose, the system furthermore has a connection device that is connected to connections of both storage units and that has two further controllable switches via which the current flow is able to be directed appropriately during charging/discharging of the energy storage device. The storage units may be charged and/or discharged by way of current pulses, in which case charge balancing between the two storage units takes place in the pulse pauses.

One disadvantage of this known energy storage system is for example a distribution of energy or charge to the two storage units that may be suboptimal depending on the application scenario and operating situation. The voltages of both storage units are matched to one another by virtue of the type of “charge balancing” provided for this purpose, namely by virtue of the two storage units being connected in parallel. This results in a charge distribution that is not known exactly and also cannot be influenced. As a result, it is not possible to make optimum use of the advantages of the hybrid storage concept, for instance when it comes to combining a high storage capacity as well as possible with a high performance, including fast-charging capability, of the energy storage system.

Another energy storage system in accordance with the hybrid storage concept is known for example from DE 10 2015 007 405 A1 and has an electrical energy storage device having first storage modules and second storage modules, wherein the first storage modules are each formed from a high-energy cell (HEC) and a controllable bidirectional energy transfer unit and the second storage modules are each formed from a high-power cell (HPC) and a controllable bidirectional energy transfer unit. The controllable energy transfer units (for example DC/AC converters) are connected in parallel at output and are connected to a power supply grid that is to be supplied with power by the energy storage system.

One disadvantage of this known energy storage system is likewise a distribution of energy to the two storage units that may not be optimal depending on the application scenario and operating situation. All that is described explicitly in this connection in the publication is that for example only the first storage modules (HEC) are discharged during discharging with a low power demand, and the second storage modules (HPC) are additionally discharged in parallel if a specified power threshold value is exceeded. In this respect, this prior art does not, in practice, focus on further improved or optimized usability of the main advantages of the hybrid storage concept.

By way of example, in BEV applications, the arguments for such known designs of the hybrid storage concept have not been sufficient up to now to achieve widespread market penetration. On the contrary, the dominant concepts in this field are ones that many customers consider inconvenient, such as for example opportunity charging (small battery, short range and fast recharging at any time) or overnight charging (large battery, long range and slow overnight recharging).

The combination of different battery cell types (HEC, HPC) in accordance with a hybrid storage concept in an energy storage device provides more flexibility in terms of the design of the electrical characteristics of the energy storage device. In the specific designs of corresponding energy storage systems proposed up to now, however, negative properties in practice often also add up, as it were, which led to suboptimal solutions, for example with regard to costs and/or the weight of such systems.

### SUMMARY OF THE INVENTION

One object of the present invention is therefore, in the case of energy storage, to eliminate the abovementioned disadvantages of the prior art and, in the case of a hybrid storage concept, to enable improved usability of the respective specific high-energy cells (HEC) and high-power cells (HPC) and thus to enable an improvement in the performance characteristics of an energy storage system in practice.

Depending on the application scenario, as already explained, numerous physical parameters may be of relevance to the performance characteristics of an energy storage system, for example
storage capacity or energy density,
load capacity or power density, be this with regard to discharge processes (for example powerful current supply to an electrical consumer) and/or charging processes (for example fast-charging capability, be this with regard to partial or complete charging or recharging),
ageing behavior, service life and cycle stability,
costs and weight.

According to a first aspect of the present invention, the abovementioned object is achieved by an energy storage system as described. The energy storage system according to the invention has:
an electrical energy storage device having a first storage unit consisting of high-power cells (HPC) and a first connection for charging and discharging the high-power cells, and having a second storage unit consisting of high-energy cells (HEC) and a second connection for charging and discharging the high-energy cells,
a controllable bidirectional energy transfer unit, connected to the first connection, on the one hand, and to the second connection, on the other hand, in order to enable energy to be transferred between the first storage unit and the second storage unit,
a connection device connected to the first connection and intended to charge and discharge the electrical energy storage device,
a recording device for recording operating parameters of the electrical energy storage device, having at least one state parameter of the high-power cells and one state parameter of the high-energy cells,
a control device for controlling the energy transfer unit in accordance with a transfer algorithm that makes provision to control the energy transfer unit in accordance with a transfer strategy as a function of the recorded operating parameters, wherein the transfer strategy provides a specification of setpoint values or setpoint value ranges for a charge state of the high-power cells and a charge state of the high-energy cells.

The energy storage system according to the invention enables improved usability of the respective specific high-energy cells (HEC) and high-power cells (HPC), and thereby improved performance characteristics of the energy storage system.

The connecting of the connection device that serves to charge/discharge the electrical energy storage device to the first connection, that is to say on the first storage unit, hereinafter also referred to as HPC storage unit, enables very direct and thus loss-free charging/discharging of the HPC storage unit with comparatively high power. In the event of an additional power demand, the second storage unit, hereinafter also referred to as HEC storage unit, may also be used by controlling the energy transfer unit accordingly. The energy transfer unit (power electronics) may be dimensioned, in terms of power, in a manner adapted to the load capacity (maximum power) of the HEC storage unit. It is possible to achieve a distribution of the energy or charge to the two storage units during operation of the energy storage system, or a distribution that is optimized for the specific application scenario, by virtue of the control device executing a transfer algorithm that makes provision to control the energy transfer unit in accordance with a transfer strategy as a function of certain operating parameters recorded in the electrical energy storage device, wherein this transfer strategy provides a specification of setpoint values or setpoint value ranges for a charge state of the high-power cells and a charge state of the high-energy cells (within which for example a setpoint value or setpoint value range for a ratio of the two charge states should also fall). The transfer algorithm or the transfer strategy carried out thereby may be implemented for example in a program-controlled manner, for instance by way of control software running in the control device.

The “operating parameters” of the electrical energy storage device that are to be recorded may be any physical quantities in the broadest sense, provided they are suitable for characterizing a certain operating state of the energy storage device. According to the invention, at least one “state parameter” of the high-power cells (HPC) and one state parameter of the high-energy cells (HEC) are recorded as operating parameters. Such a state parameter characterizes a certain property of the state of the battery cells (HPC or HEC) in question and thus of the storage unit formed therefrom.

In one embodiment of the invention, a “charge state” of the cells in question is provided as a state parameter of the high-power cells (HPC) and/or of the high-energy cells (HEC), this being understood to mean a parameter that characterizes, in quantitative terms, the extent to which the battery cells in question (and thus the storage unit formed therefrom) are charged. By way of example, what is known as the state of charge (SoC) may thus be provided as such a charge state, that is to say a parameter that indicates the currently stored electric charge in relation to the nominal value of the maximum storable electric charge (capacity of the battery). As an alternative thereto, within the scope of the invention, however, a parameter that characterizes the energy stored in the cells in question rather than the electric charge may be provided for example as a charge state.

In one embodiment of the invention, a “power parameter” is provided as a state parameter of the high-power cells (HPC) and/or high-energy cells (HEC), the power parameter characterizing, in quantitative terms, the extent to which the battery cells in question (and thus the storage unit formed therefrom) are “able to be loaded” with regard to charging and/or discharging. What is known as the state of power (SoP) parameter may for example be provided for this purpose, that is to say a parameter that indicates a peak electric power that is able to be maintained currently or for a certain short period of time (without violation of specified specifications) in relation to a nominal power.

As an alternative or in addition to at least one such “power parameter” (among the operating parameters to be taken into consideration by the transfer strategy), for example, a parameter of the cells in question that quantifies another property that characterizes their “performance state” may also be provided as a state parameter of the high-power cells (HPC) and/or of the high-energy cells (HEC). By way of example, such a “performance state” (parameter) may be a parameter that characterizes a “current storage capacity” of the battery cells in question (and thus of the storage unit formed therefrom) with regard to degradation and ageing processes. By way of example, what is known as the state of health (SoH) may be provided as such a performance state, that is to say a parameter that indicates the maximum electric charge currently able to be stored in relation to the nominal value of the maximum storable electric charge.

In one embodiment, the charge state (for example SoC) is provided as a state parameter of the high-power cells (HPC). As an alternative or in addition, a power parameter (for example SoP) may however also be provided as a state parameter of the high-power cells.

In one embodiment, at least the charge state (for example SoC) is provided as a state parameter of the high-energy cells (HEC).

The “high-power cells” (HPC) and “high-energy cells” (HEC), within the scope of the invention, are battery cells of various types, wherein these terms should be understood to be mutually related to one another, that is to say these terms are not intended to imply any restriction with regard to absolute values of a load capacity (maximum power or maximum current) or a storage capacity (energy or charge) of the battery cell or a storage unit formed by an interconnection of such battery cells.

To classify the two different types of battery cells used, it is possible for example to apply what is known as the “C rating”, defined as the quotient of the maximum discharge current and the nominal capacity (or else quotient of the maximum discharge power and the nominal energy capacity) of the battery cell or of a relevant storage unit. The C rating may thus also be regarded as the reciprocal of the time interval within which a fully charged battery cell or storage unit is completely discharged with the maximum discharge current.

Within the meaning of the invention, the cells with the larger C rating then constitute the high-power cells (HPC) and the cells with the smaller C rating constitute the high-energy cells (HEC), wherein it should be noted that the terms “HPC” and “HEC”, within the meaning of the invention, are not intended to mean any restrictions with regard to absolute parameters concerning “power density” or “energy density” or their ratio (as may be quantified for example by the above C value), but rather merely express a corresponding relative (interrelated) difference between the properties of the two types of cells used.

Two examples regarding the C value as defined above: In the case of a storage unit with a nominal capacity of 20 Ah and a maximum discharge current of 200 A, the C rating is: (200 A)/(20 Ah)=10×(1/h). The storage unit is therefore able to be discharged in 0.1 h (=6 min). In the case of a storage unit with a nominal capacity of 50 Ah and a maximum discharge current of 25 A, the C rating is (25 A)/(50 Ah)=0.5×(1/h). The storage unit is therefore able to be discharged in 2 h (=120 min).

In one embodiment of the invention, the high-power cells (HPC) have a C value greater than 1×(1/h), and may be greater than 2×(1/h), and/or the high-energy cells (HEC) have a C value less than 1×(1/h), and may be less than 0.5×(1/h).

In one embodiment, the high-power cells (HPC) have a C value that is greater than the C value of the high-energy cells (HEC) by at least a factor of 2, and may be at least a factor of 5.

The cells may be electrochemical battery cells. In this regard, mention may be made for example of lithium-ion cells based on transition metal mixed oxides of lithium, wherein for example cells based on lithium-nickel-cobalt-manganese oxide (NCM) may be provided as high-energy cells and for example cells based on lithium titanate (LTO) may be provided as high-power cells.

In one embodiment of the invention, the high-power cells (HPC) are provided for example as ultracapacitors or as LTO cells. As an alternative, LFP (lithium-ferrophosphate) cells may also be provided for this purpose, for example.

In one embodiment of the invention, the high-energy cells (HEC) are provided for example as LFP or NCM cells. As an alternative, LNMO (lithium-nickel-manganese-oxide) cells may also be provided for this purpose, for example.

The HEC storage unit and the HPC storage unit are each formed from a multiplicity of identical battery cells, such as electrochemical battery cells, interconnected in series and/or in parallel.

In one embodiment, a respective interconnection of the cells forming a plurality of “modules”, hereinafter also referred to as subunits, is provided in the HEC storage unit and/or the HPC storage unit, wherein these subunits have respective negative and positive connection contacts via which these subunits are able to be supplied with current independently of one another, that is to say are able to be charged or discharged independently of one another. With regard to a specific design of such an interconnection, it is possible to look to the prior art of electrical energy storage devices, from which such interconnections are known.

For the cells each interconnected to form a module, provision may be made, within the scope of the invention, to carry out what is known as balancing in order thereby to equalize the charge states of these cells or at least ensure that their charge states each remain within a certain range (defined in the specific application). For the specific design of such battery cell balancing, it is possible to look to the prior art (for example “active” or “passive” balancing).

If, within the scope of the invention, provision is made for such a respective interconnection to form subunits in the HEC storage unit and/or the HPC storage unit, then the abovementioned negative and positive connection contacts are connected to electrical connection contacts of the “connection” of the storage unit in question, which in turn is connected to the controllable bidirectional energy transfer unit.

The term “connection” in the terms “first connection” (of the HPC storage unit) and “second connection” (of the HEC storage unit) should be understood broadly in this regard and is not limited to the simplest case of a two-pole connection (a negative pole and a positive pole of the storage unit). On the contrary, the “connection” of each storage unit, with regard to the interconnection explained above forming multiple subunits within the HPC storage unit and/or the HEC storage unit, may also have a corresponding multiplicity of electrical connection contacts.

In many conventional electrical energy storage devices that pursue a modular approach, typically around 8-18 cells are for example combined in each case to form a subunit (module) (able to be supplied with current separately), and then in turn 6-40 such subunits are interconnected to form a series line. This more specific concept may also be provided for the interconnection of the cells in the HPC and HEC storage units of the energy storage system according to the invention.

One example in this regard: Assuming that a storage unit has 40 subunits interconnected in series (and each formed from an associated portion (for example 8 unit parts) of the cells in question), then 41 connection contacts may be provided on this storage unit in order thereby to be able to operate (charge and discharge) the 40 subunits separately from one another. In this case, the “connection” of the storage unit may thus have a corresponding number of 41 electrical connection contacts that are connected to the controllable bidirectional energy transfer unit (generally: “n+1” connection contacts in the case of “n” subunits interconnected in series).

This achieves, when energy is transferred between the HPC storage unit and the HEC storage unit, enabling in each case a dissipation or supply of energy that is defined individually (for each individual subunit) for the multiple subunits.

In one development of this embodiment, provision is made, when energy is transferred between the HPC storage unit and the HEC storage unit, for “subunit balancing”, as it were, to be performed at the one or more storage units (possessing subunits). It is thereby possible to equalize the charge states of the subunits (modules) forming a storage unit (HPC or HEC storage unit) and/or at least ensure that these charge states each remain within specific ranges defined in the specific application.

If provision is made for an interconnection of the high-power cells (HPC) and/or high-energy cells (HEC) to form subunits, then the operating parameters recorded within the scope of the invention and to be taken into consideration by the transfer strategy, such as “state parameters” of the high-power cells (HPC) and/or high-energy cells (HEC), such as for example SoC, SoP, SoH, etc., may be recorded individually for each subunit and taken into consideration by the transfer strategy when controlling the energy transfer.

The bidirectional energy transfer unit serves to transfer energy between the HPC storage unit and the HEC storage unit and, for this purpose, is controlled accordingly by the control device (in accordance with the transfer strategy). By way of example, the energy transfer unit may have one or more DC/DC converters. In the case of an interconnection of the cells in the HPC storage unit and/or the HEC storage unit to form separately operable subunits, the energy transfer unit may have a DC/DC converter arrangement (for example having multiple DC/DC converters) that is designed, on the one hand, to dissipate or supply a respective “partial energy” via the respective connection contacts of the subunits and, on the other hand, to supply or dissipate the “sum of the partial energies” to the other storage unit via the connection of the other storage unit (wherein, in this case too, the supply or dissipation may again be provided in a manner divided into partial energies for respective subunits of the other storage unit). The abovementioned “subunit balancing” may thereby be achieved.

In one embodiment of the invention, the number of subunits of the HPC storage unit is equal to the number of subunits of the HEC storage unit. As an alternative thereto, the respective numbers of subunits, that is to say of the HPC storage unit, on the one hand, and of the HEC storage unit, on the other hand, may also be different from one another.

It should be noted in this connection that respective nominal voltages (“terminal voltages”) of the HPC and HEC storage units, which may be present for example in each case between the ends of a series line formed from a large number of subunits of the storage unit, may for example be provided so as to be at least approximately of the same value. As an alternative thereto, however, nominal voltages for the HPC and HEC storage units having very different values may also easily be provided within the scope of the invention. Such different nominal voltages between the HPC and HEC side need to be taken into consideration accordingly, if need be (depending on the circuit concept of the energy transfer unit), in the specific design of the energy transfer unit.

Different nominal voltages (differing from one another for example by at least a factor of 2, and may be at least a factor of 5) of the HPC and HEC storage units are provided in many cases. One example in this regard: Depending on the application scenario, an embodiment of the present invention provides a “modular” design for the energy storage system in the sense that the HPC storage unit, the HEC storage unit and the energy transfer unit are not all structurally combined to form a unit (for example in a common housing). In this case, the energy storage system thus consists of multiple modules that are spatially separate from one another and that need to be connected to one another via an electrical line arrangement. A lower (or higher) voltage level of a storage unit, and thus also in the region of an associated line connection, may then be used for example to reduce corresponding requirements with regard to insulation (or line cross section).

In one embodiment of the invention, the energy transfer unit is able to be controlled by way of the control device so as to achieve a transfer of energy in which a time-modulated current flows through the second connection in order to charge and/or discharge the high-energy cells.

As already mentioned, the comparatively high storage capacity or energy density of the high-energy cells (HEC) at the same time means a load capacity or power density of the HEC storage unit that tends to be lower. Therefore, the use of the HEC storage unit as provided for in the invention is problematic insofar as, for example, the load capacity of the overall system (energy storage system) is limited accordingly, both during discharging and during charging of the energy storage device. This limits fast-charging capability, for example.

The embodiment in which a time-modulated current flows through the second connection in order to charge and/or discharge the high-energy cells however makes it possible to mitigate the limitation of the load capacity of the energy storage system, since it has proved that, depending on the specific type of battery cell, it is possible to achieve a significant increase in load capacity by using a time-modulated (variable) current to charge or discharge the battery cells (compared to charging/discharging using a constant current).

In practice, this embodiment may thus be used to increase the load capacity of the energy storage system during charging and/or discharging. As an alternative or in addition, the benefit of this embodiment may however also be that of extending the service life of the storage unit in question.

In any case, this embodiment contributes to improving the performance characteristics of the energy storage system, since the conflicts of objectives explained at the outset (for example with regard to storage capacity, load capacity, for example with regard to fast-charging capability and charging times, and ageing behavior, etc.) are thereby mitigated.

In one development of this embodiment, provision is made for the transfer strategy to furthermore provide a specification of one or more modulation parameters for the time-modulated current.

Such a “modulation parameter” may constitute for example a quantitative measure of a certain property of the time-modulated current, such as for example a frequency in the case of a periodic temporal profile of the current.

The specification of the one or more modulation parameters may be provided as a function of the recorded operating parameters (and/or “external operating parameters or control commands” described further below), for instance in order for example to optimize the benefit of the temporal modulation in a manner appropriate for the current operating situation (be this the energy storage unit or a device constituting its installation environment, such as for example a vehicle). Each such modulation parameter may be modified and adapted inline, for example adaptively in accordance with suitable cell criteria defined by the electrochemistry of the cells. It is thereby possible for example to extend the fast-charging time, including of the high-energy cells (HEC). Overall, it is thereby possible for example to shorten a charging time of the HEC storage unit (in relation to the high-energy cells) even further.

In one development, provision is made for the time-modulated current to have a pulse current component and/or a ripple current component.

The term “pulse current component” may in this case denote a sequence of more or less pronounced and clearly distinguishable pulses that is present in the temporal profile of the current, wherein a fluctuation magnitude (amplitude) of this sequence of pulses corresponds at least approximately to a fluctuation magnitude of the temporal profile of the current.

The pulses may be square-wave pulses, for example, or sinusoidal pulses, for example. Triangular pulses may also be provided, for example. In the case of temporally equidistant identical pulses, the pulse current component constitutes a periodic current component of the time-modulated current. As an alternative thereto, however, the pulse current component may also be formed by pulses the time interval between which and/or the pulse shape of which (for example a pulse-pause ratio) varies systematically in the temporal profile of the current.

With the convention of designating the “positive” polarity (current direction) of the current as the one that causes the desired transfer of energy, that is to say from the HPC storage unit to the HEC storage unit or vice versa, an average value of the time-modulated current must be positive. However, this does not rule out negative values being able to be assumed in the temporal profile of the current. Such “negative current flow phases”, which are relatively brief and/or associated with small absolute values of the current strength, may be used depending on the specific battery cell type (for example in order to avoid the formation of dendrites in lithium-ion cells through depolarization of the electrode).

The fluctuation magnitude (amplitude) of the sequence of pulses and thus of the pulse current component may be defined by specified lower and upper limits (of the current strength of the current), wherein, in accordance with what is stated above, the upper limit must be positive, but the lower limit may also be negative if negative current flow phases are provided.

With regard to characterizing the pulse current component, for example, at least one of the following properties may be quantified by the one or more modulation parameters: frequency of the pulse sequence, amplitude of the pulses, lower limit, upper limit, pulse-pause ratio. As an alternative or in addition, provision may be made for example to specify a specific pulse geometry by way of the one or more modulation parameters (for example square-wave, sinusoidal or triangular pulses).

The term “ripple current component” is intended to refer to a sequence of fluctuations (AC current component) that is present in the temporal profile of the current and that may for example be superimposed on a DC current, wherein a fluctuation magnitude (amplitude) of the sequence of fluctuations is significantly smaller (for example by at least a factor of 5, or at least a factor of 10) than the current strength of the DC current. As an alternative, the sequence of fluctuations may be superimposed on a time-varying current (for example a “pulse current component”), wherein, in this case, the fluctuation magnitude (amplitude) of the sequence of fluctuations is significantly smaller (for example by at least a factor of 5, or at least a factor of 10) than a fluctuation magnitude of the time-varying current and a frequency or fundamental frequency of the fluctuations is substantially greater (for example by at least a factor of 5, or at least a factor of 10) than a corresponding frequency or fundamental frequency of the time-varying current.

The fluctuations constituting the ripple current component may be for example square-wave or for example sinusoidal or for example triangular fluctuations. The ripple current component may constitute a periodic current component of the time-modulated current. As an alternative thereto, however, the ripple current component may also be formed by non-periodic fluctuations.

With regard to characterizing the ripple current component, for example, at least one of the following properties may be quantified by the one or more modulation parameters: frequency of the fluctuations (ripple), amplitude of the fluctuations.

If the high-power cells (HPC) and/or high-energy cells (HEC), as already explained above, are interconnected to form respective subunits (modules) of the one or more storage units in question, and the recorded operating parameters to be taken into consideration by the transfer strategy include one or more “state parameters” (such as for example SoC, SoP, SoH, etc.) recorded individually for each subunit of the one or more storage units in question, then the transfer strategy, in the case of controlling the energy transfer “with a time-modulated current”, may likewise make provision for individual specification of modulation parameters for these subunits. This is intended to mean that the individual “current profiles” of the currents each flowing during such an energy transfer (from HPC to HEC or vice versa) during the discharging or charging of subunits are each specified individually (for each subunit).

In one embodiment of the invention, provision is made for the energy storage system to furthermore have a data interface via which an external device is able to supply, to the control device:
control commands, wherein the transfer strategy is modified as a function of supplied control commands, and/or
external operating parameters, wherein the transfer strategy also makes provision to control the energy transfer unit as a function of supplied external operating parameters.

The “external device” may for example be a device that is connected communicatively to the energy storage system or its control device (for example in wired form, for example via a digital data transmission bus) in the use situation and that is part of an installation environment of the energy storage system. If the energy storage system is installed for example on board a vehicle, for instance in order to supply electrical energy to an electric drive system of the vehicle, then the external device may for example be a central control device (for example a program-controlled computer device), or another control device belonging to the vehicle.

The external device may be a device in which data are available (for example stored and/or computed from stored data), the data containing information about a current and/or expected future use of the energy storage system. Such data as they are, or data computed from such data by way of further processing carried out in the vehicle, may be supplied to the control device of the energy storage system as external operating parameters.

In the use example of being used for the electric drive system of a vehicle, the data or elements thereof may for example represent one or more of the following “external operating parameters”: current accelerator pedal position, current drive power (including negative drive power in the case of recuperation), instantaneous current strength of a current with which the electrical energy storage device is currently being discharged/charged. As an alternative or in addition, the data or elements thereof may for example represent the same operating parameters as indicated above, but not in the form of instantaneous values, but rather expected or predicted future values.

Data relating to the future could originate from on board the vehicle, for example from a navigation system, for instance representing characteristics of a current road determined by the navigation system (for example incline, gradient, curves, traffic lights, etc.) and/or the characteristics of a route defined in the navigation system by the user of the vehicle (for example height above sea level along the route and/or at the start and/or destination, etc.).

In another embodiment, the “external device” is for example a server device that is connected communicatively to the vehicle via a mobile network, such that it is possible to modify the transfer strategy in the energy storage system of the vehicle by way of control commands supplied via the mobile network (in order to achieve optimization of the transfer strategy). Such control commands may be generated in this case for example based on data from a fleet manager of a multiplicity of vehicles, which are each likewise equipped with an energy storage system of the type described here.

In one embodiment, the external operating parameters include a current power demand and/or a predicted future power demand.

The transfer strategy implemented by way of the control device may take into consideration the data supplied by the external device when controlling the energy transfer unit in such a way that the operation of the energy storage system is further improved or optimized. By way of example, provision may be made for this purpose for the specification of the setpoint values or setpoint value ranges for the charge state of the high-power cells and/or the charge state of the high-energy cells to be modified as a function of the received data.

In one embodiment, provision is made for the HPC storage unit and/or the HEC storage unit to each have multiple subunits that are able to be operated separately from one another and that are each formed from an associated portion of the high-power cells or high-energy cells of the storage unit in question, and for the controllable bidirectional energy transfer unit, in conjunction with the first connections (on HPC storage unit) and the second connections (on HEC storage unit), to be designed, during the transfer of energy between the HPC storage unit and the HEC storage unit, to enable a dissipation or supply of a respective partial energy that is able to be defined in each case individually by the control device for the multiple subunits.

In one embodiment, the electrical energy storage device has an energy storage capacity of at least 20 kWh, and may be at least 40 kWh.

In one embodiment that may be used for many applications, the second storage unit (HEC) has an energy storage capacity greater than the energy storage capacity of the first storage unit (HPC). This may be by at least a factor of 2, or may be at least a factor of 5.

According to a further aspect of the invention, the object mentioned at the outset is achieved by a method for operating an energy storage system of the type described here, including the following steps:
recording operating parameters of an electrical energy storage device of the energy storage system, including at least one state parameter of high-power cells (HPC) of a first storage unit (HPC storage unit) of the electrical energy storage device and one state parameter of high-energy cells (HEC) of a second storage unit (HEC storage unit) of the electrical energy storage device, and
executing a transfer algorithm that makes provision to transfer energy between the HPC storage unit and the HEC storage unit in accordance with a transfer strategy as a function of the recorded operating parameters, wherein the transfer strategy provides a specification of setpoint values or setpoint value ranges for a charge state of the high-power cells and a charge state of the high-energy cells.

The embodiments and special designs described here for the energy storage system according to the invention may, individually or in any combination, also be provided in the same way as embodiments or special designs of the method according to the invention, and vice versa.

In one embodiment of the method, the operating parameters to be recorded furthermore include a current strength of a current flowing through a connection device of the energy storage system during charging or discharging of the electrical energy storage device. As an alternative or in addition, information about this current strength could also be received for example as one of the abovementioned external operating parameters.

In one embodiment, it is possible, in accordance with the transfer algorithm, to control a transfer of energy in which a time-modulated current flows through a connection of the HEC storage unit in order to charge and/or discharge the high-energy cells (HEC). Depending on the specific implementation of the energy transfer (for example by way of a DC/DC converter arrangement), an appropriately time-modulated current may also in this case flow from the energy transfer unit to a connection of the HEC storage unit. However, it is also conceivable for the latter current to flow from the energy transfer unit to the connection of the HEC storage unit in “smoothed” form (DC current).

In one embodiment, the method furthermore includes receiving control commands to modify the transfer strategy as a function of received control commands, and/or external operating parameters for controlling the transfer of the energy also as a function of received external operating parameters.

According to yet another aspect of the invention, the use of an energy storage system of the type described here and/or of a method of the type described here to supply electrical energy to an electric drive system of a vehicle is proposed.

Provision may also be made for use for example in order to supply electrical energy to a power supply grid for consumers able to be connected thereto, for example in connection with the feeding of electrical energy from renewable energy sources into such a power supply grid.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is described in more detail below based on exemplary embodiments with reference to the accompanying drawings, in which, in each case schematically:

FIG. 1 shows a block diagram of an energy storage system together with its installation environment (drive system of a BEV) according to one exemplary embodiment,

FIGS. 2 to 6 show different exemplary temporal profiles of a time-modulated current used to charge and discharge high-energy cells (HEC) of the energy storage system, and

FIG. 7 shows a flowchart of an operating method performed by a control device of the energy storage system.

### DETAILED DESCRIPTION OF THE PREFERRED EMBODIMENTS

The following description of the preferred embodiment(s) is merely exemplary in nature and is in no way intended to limit the invention, its application, or uses.

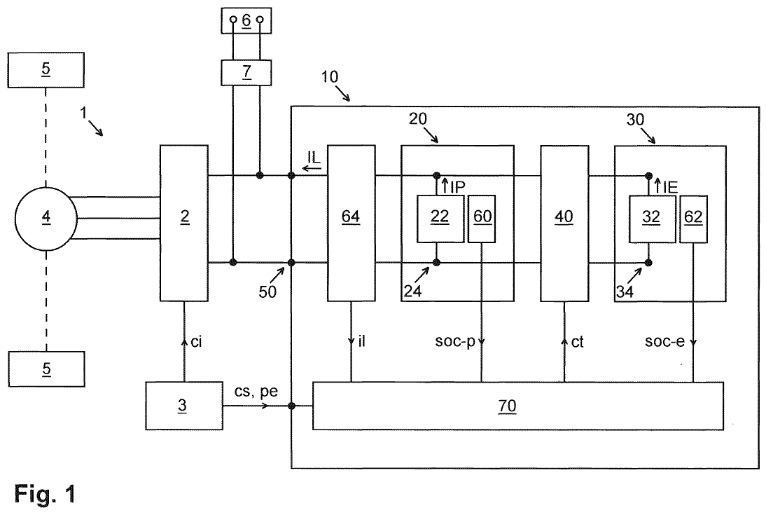

FIG. 1 shows an energy storage system 10 that has an electrical energy storage device (rechargeable battery) having a first storage unit 20 and a second storage unit 30.

The first storage unit 20 (“HPC storage unit”) is formed of high-power cells 22 and has a first connection 24 for charging and discharging the high-power cells 22. The second storage unit 30 (“HEC storage unit”) is formed of high-energy cells 32 and has a second connection 34 for charging and discharging the high-energy cells 32.

In the example illustrated, the high-power cells 22 are cells based on lithium titanate (LTO) and the high-energy cells 32 are cells based on lithium-nickel-manganese-cobalt oxide (NCM).

In both storage units 20, 30, the battery cells 22, 32 are each interconnected in series and in parallel such that subunits that are able to be supplied with current (not illustrated in the figure) separately (independently of one another) are formed in each storage unit.

It is assumed in the example that, in each of the two storage units 20, 30, the subunits respectively formed from an associated portion of the high-power cells 22 and high-energy cells 32 are interconnected in series, such that a respective “voltage of the storage unit” 20 and 30 is given as the sum of partial voltages of the respective individual subunits and is present at the connection contacts of the respective connection 24 and 34 that are visible in FIG. 1.

The energy storage system 10 furthermore has a controllable bidirectional energy transfer unit 40 that is connected to the first connection 24, on the one hand, and to the second connection 34, on the other hand, in order to bring about a transfer of energy in the direction from the first storage unit 20 to the second storage unit 30 or vice versa during operation of the energy storage system 10 when controlled appropriately by way of a control signal ct.

Provision is made for a connection device 50 connected to the first connection 24 in order to charge and discharge the electrical energy storage device 20, 30.

The energy storage system 10 furthermore has a control device 70 that generates the abovementioned control signal ct and by way of which, during operation of the energy storage system 10, the energy transfer unit 40 is controlled in accordance with a transfer algorithm that is defined, in the example, by a control program running in the control device 70 in the form of a program-controlled computer device.

The energy transfer unit 40 is controlled here in accordance with a transfer strategy as a function of certain operating parameters, which include a current charge state “soc-p” of the high-power cells 22 and a current charge state “soc-e” of the high-energy cells 32. According to one development, these operating parameters furthermore include a current power state (for example state of power, “SoP”, as it is known) at least for the high-power cells 22 (HPC storage unit).

The charge states soc-p and soc-e may each be defined as usual as what is known as a state of charge (SoC), that is to say as a parameter that specifies the currently stored charge in relation to the nominal value of the maximum storable charge (capacity of the battery).

In order to record the current charge states soc-p, soc-e, the two storage units 20, 30 are each equipped with a respective battery monitoring sensor system 60 and 62. Such a battery monitoring sensor system is known as such from the prior art. It is therefore possible for example to turn to this prior art for the specific design of the sensor systems 60, 62. In the example, the recorded operating parameters soc-p, soc-e are supplied to the control device 70 as input variables of the transfer algorithm.

Within the scope of the invention, however, the term “charge state” should be understood broadly as any parameter suitable for quantifying the charge in question. As an alternative to the example illustrated, this parameter could therefore also refer, instead of to electric charge, for example, to the “loading” with electrical energy stored in the storage unit in question.

In the example, the energy storage system 10 furthermore has a sensor system or current-measuring device 64 for measuring a load current IL currently flowing at the connection device 50 of the energy storage system 10. The current-measuring device 64 outputs a sensor signal il representative of the current IL, the sensor signal likewise being supplied to the control device 70 as illustrated in FIG. 1, for example as a further operating parameter for consideration as part of the transfer strategy.

If the currents flowing through the first and second connections 24, 34 of the two storage units 20, 30 as shown in FIG. 1 are denoted IP and IE, then: IL=IP+IE, that is to say the load current IL corresponds to the sum of the currents at the two storage units 20, 30, a convention being assumed here whereby positive currents in each case mean discharging and negative currents in each case mean charging of the energy storage system 10 or of the respective storage unit 20 and 30 in question.

In accordance with the abovementioned transfer strategy for controlling the energy transfer unit 40, setpoint values or setpoint value ranges for the charge state soc-p of the high-power cells 22 and the charge state soc-e of the high-energy cells 32 are provided.

It should be noted in this regard that the load current IL (discharge or charge current of the energy storage system 10) is specified “externally” in the respective application situation, such that a corresponding reduction or increase in a total charge of the energy storage system 10 (sum of the charges of the storage units 20, 30) is already defined by this load current IL in the illustrated example. However, the transfer strategy and, based thereon, controlling of the energy transfer unit 40 may influence how such a reduction or increase in the total charge “is distributed to the two storage units 20, 30”.

The specification of setpoint values or setpoint value ranges for the charge states, the parameters soc-p, soc-e in the example, therefore means that the control device 70 attempts, as far as possible, always to modify the values of these parameters soc-p and soc-e or for example the corresponding stored electric charges (or practically equivalent: stored electrical energies) of the two storage units 20, 30 by controlling the energy transfer unit 40 in such a way that the actual values are changed in the direction of the setpoint values or setpoint value ranges.

If and for as long as the relevant actual values recorded as operating parameters or resulting therefrom assume setpoint values specified by the transfer strategy or lie within setpoint value ranges specified by the transfer strategy, then the control device 70 brings about inactivation of the energy transfer unit 40 by way of the control signal ct.

In FIG. 1, the first and second connections 24, 34 of the two storage units 20, 30 and their line connections to the energy transfer unit 40 are each illustrated in simplified two-pole form, that is to say with only two connection contacts and connection lines. In view of the abovementioned design of the storage units 20, 30 with series-interconnected subunits, the connections 24, 34 may actually each have a corresponding multiplicity of connection contacts that are connected to the energy transfer unit 40 via a corresponding multiplicity of connection lines.

The controllable bidirectional energy transfer unit 40 may be designed, in conjunction with the first and second connections 24, 34, to carry out a dissipation or supply of a respective partial energy that is defined in each case individually by the control device 70 for the multiple subunits during the transfer or the exchange of energy between the first and second storage units 20, 30. This makes it possible to also carry out balancing with regard to the respective subunits during the energy transfer between the storage units 20, 30. In this case, for example, when energy is transferred from the first storage unit 20 to the second storage unit 30, the energy to be transferred is taken from “relatively well charged” subunits of the storage unit 20 and/or transferred to “relatively poorly charged” subunits of the storage unit 30 (or vice versa, that is to say energy is taken from “relatively well charged” subunits of the storage unit 30 and/or transferred to “relatively poorly charged” subunits of the storage unit 20).

Information required for such balancing of the subunits within the storage units 20, 30 may, in the example, be provided by the battery monitoring system (sensor system 60, 62) and thus for example transmitted to the control device 70 by way of the signals soc-p, soc-e. Irrespective of this, the battery monitoring system may also be designed to carry out balancing with regard to individual battery cells within each of the subunits within the storage units.

FIG. 1 illustrates, as one example of an application scenario of the invention, the use of the energy storage system 10 to supply electrical energy to an electric drive system 1 of a vehicle.

The electric drive system 1 has an inverter 2, connected to the connection device 50 of the energy storage system 10, for supplying current to an electric drive machine 4.

The electric drive machine 4 represents a drive component in a drivetrain, symbolized by dashed lines in FIG. 1, of the vehicle for driving vehicle wheels 5. In the example, the vehicle is a pure electric vehicle (BEV), but could also for example be a hybrid vehicle additionally having a combustion engine.

The electric drive system 1 furthermore has a control device 3 by way of which the inverter 2 is controlled during operation of the vehicle. For this purpose, the control device 3 generates a control signal ci to be supplied to the inverter 2 based on a current power demand supplied to the control device 3 (for example based on an accelerator pedal position, etc.).

The current power demand may for example represent a demand for a certain electric power, or a certain torque or a certain speed, etc. when driving the vehicle. The control device 3 satisfies such a power demand by causing a current to be supplied to the drive machine 4 with a corresponding electric power, this being provided by discharging the energy storage system 10 accordingly via the connection device 50 and the inverter 2.

In order to enable recuperation operation of the drive machine 4 (when braking the vehicle), the inverter 2 is bidirectionally operable and is able to be controlled accordingly by the control signal ci. The control device 3 is thus also able to satisfy “negative” power demands, in which the drive machine 4, operated as a generator, generates an electric power that is able to be used, via the inverter 2 and the connection device 50, as a charging power for charging the energy storage system 10.

In addition, the energy storage system 10 may also be charged at a charging station while the vehicle is parked. For this purpose, the vehicle has a charging connection 6 (for example charging port), which is likewise connected to the connection device 50 via charging electronics (for example rectifier).

The electrical connections between the energy storage system 10, inverter 2 and charging connection 6 are illustrated in somewhat simplified form in FIG. 1 without isolating devices (for example relays, contactors) that are typically provided in practice in this field and by way of which individual ones of these components are able to be electrically decoupled from the rest of the system as required (and for example also in the case of detected faults or defects).

The control device 3 illustrated in FIG. 1 may also be designed to control such isolating devices and may represent a component (possibly functional component) of more comprehensive vehicle electronics consisting of a plurality (not illustrated in FIG. 1) of components that are formed separately but are communicatively connected to one another, for example via a digital data bus system (for example CAN bus, LIN bus, etc.).

In the example illustrated, one feature of the energy storage system 10 is that the energy transfer unit 40 is able to be controlled by way of the control device 70 so as to achieve a transfer of energy in which a time-modulated current IE flows through the second connection 34 in order to charge and/or discharge the high-energy cells 32. This increases the load capacity of the high-energy cells 32 and thus ultimately of the energy storage system 10 during charging and discharging and extends the service life of the high-energy cells 32.

In order to optimize these effects, the transfer strategy in the example furthermore provides a specification of one or more modulation parameters for the time-modulated current IE that depends on the recorded operating parameters, here for example at least on the parameter soc-e.

The time-modulated current IE may in this case have a pulse current component and/or a ripple current component, wherein it is possible for example to define the following, in each specific operating situation, by way of modulation parameters coded in the control signal ct:
presence of a pulse current component or the strength thereof, and where applicable further properties of the pulse current component, and
presence of a ripple current component or the strength thereof, and where applicable further properties of the ripple current component.

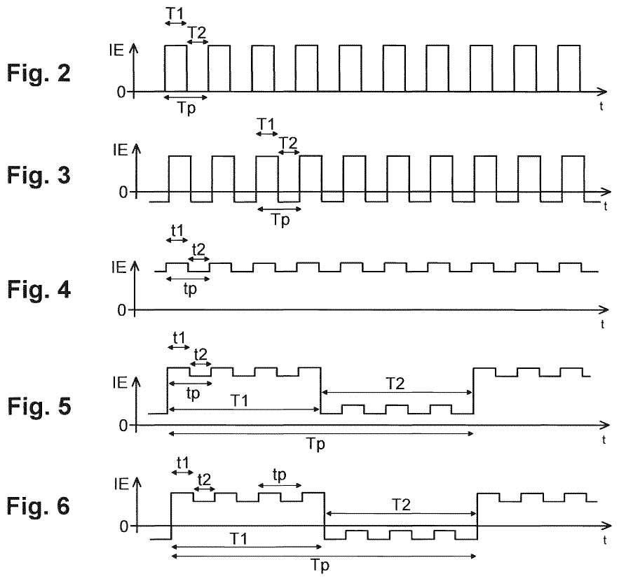

FIGS. 2 to 6 illustrate the terms “pulse current component” and “ripple current component” based on a few exemplary temporal profiles of a current IE used to charge and discharge the second storage unit (HEC) (as a function of time t).

FIGS. 2 and 3 each show a current IE that has only a “pulse current component” and is formed by a sequence of periodic square-wave pulses, wherein a fluctuation magnitude (amplitude) of this pulse sequence corresponds to a fluctuation magnitude of the temporal profile of the current IE. The pulses are square-wave in the example of FIG. 2, and FIG. 2 shows a pulse period Tp and pulse times T1 and pulse pause times T2 of this current profile.

In the example of FIG. 2, the current strength of the current IE is greater than or equal to zero at all times, whereas, in the example of FIG. 3, the current IE also assumes negative values in certain time phases or, in other words, the fluctuation magnitude (amplitude) of the pulse sequence extends into the negative value range (IE<0).

FIG. 4 shows a current IE having a “ripple current component” that is formed by a sequence of fluctuations of relatively small amplitude that is present in the temporal profile of the current (AC current component), which sequence is superimposed on a certain DC current in this example. In the example of FIG. 4, the fluctuations (ripples) are periodic and have, in this example, the shape of square-wave pulses with a pulse period tp and pulse times t1 and pulse pause times t2.

With regard to the fluctuation magnitude (amplitude) of the “ripple current component” superimposed on a DC current, this may, within the scope of the invention, for example, be at least 1%, and may be at least 5% of the current strength of the DC current. On the other hand, it is often expedient for the fluctuation magnitude of the ripple current component to be at most 40%, or at most 30%, of the current strength of the DC current.

FIGS. 5 and 6 each show a current IE having both a “pulse current component” and a “ripple current component”, wherein provision is made, in the example of FIG. 5, for the current strength of the current IE to be positive at all times, whereas, in the example of FIG. 6, the current IE also assumes negative values in certain time phases. For the sake of better visualization, a width, corresponding to the pulse period Tp, of the pulses of the pulse current component is illustrated larger in FIGS. 5 and 6 than in FIGS. 2 to 4. In the examples of FIGS. 5 and 6 as well, the fluctuations (ripples) are periodic and have the shape of square-wave pulses with a pulse period tp and pulse times t1 and pulse pause times t2.

In FIGS. 2 to 6, the “pulse current component” is illustrated as a square-wave signal only by way of example. As an alternative thereto, a different pulse shape may also be provided within the scope of the invention, be this permanently or temporarily (for example depending on a modulation parameter specification from the control device 70). The same applies to the selection of the pulse period Tp and the pulse times T1 and pulse pause times T2 visible in the figures. These may also be specified or able to vary in a wide range within the scope of the invention. However, in many application scenarios, it may be provided that T1>T2. T1 may be provided for example so as to be greater than T2 by a factor of at least 2.

With regard to the pulse period Tp in the “pulse current component”, this may be specified within the scope of the invention, for example, in a range of 0.1 ms to 10 s, corresponding to a frequency in the range of 0.1 Hz to 10 kHz, be this fixedly specified or for example variable during operation of the energy storage system (depending on a modulation parameter specification from the control device). In one embodiment, Tp is in a range of 0.1 ms to 0.1 s.

FIG. 3 illustrates a fluctuation magnitude (amplitude) of the pulse current component, by way of example, as extending largely in the positive value range. As an alternative thereto, provision may also be made within the scope of the invention for this fluctuation magnitude to extend largely in the negative value range. If a current IE having a fluctuation magnitude extending into the negative value range is provided (as is the case for example in FIG. 3), it is usually provided for a “positive” power, considered on average over time, corresponding to the areas (integrals) of the segments running in the positive value range, to be significantly greater than a “negative” power corresponding to the areas of the segments running in the positive range. Such a positive power may be provided so as for example to be greater than the negative power by a factor of at least 2, and may be at least 5. In other words, a ratio T1/T2 should be chosen to be greater the further the “negative current peaks” extend into the negative value range. In one exemplary embodiment, T1>100×T2.

With regard to the fluctuation magnitude (amplitude) of the “ripple current component” superimposed on a pulse current, this may, within the scope of the invention, for example, be at least 1%, and may be at least 5% of the (overall resultant) fluctuation magnitude of the current IE. On the other hand, it is often expedient for the fluctuation magnitude of the ripple current component to be at most 40%, or at most 30%, of the fluctuation magnitude of the current IE.

Returning to FIG. 1 and the previously mentioned specification of one or more modulation parameters, a dependency, programmed for this purpose in the control device 70, of each such modulation parameter on one or more of the recorded operating parameters (such as for example charge state soc-e, etc.) may be based on the results of tests carried out in advance on the type of high-energy cells in question.

In the example illustrated, another feature is that the energy storage system 10 has a data interface via which control commands cs and/or external operating parameters pe are able to be supplied to the control device 70 by an external device, in the example the vehicle-side control device 3, during operation of the energy storage system 10.

Such control commands cs have the effect here that the transfer strategy is modified as a function of the specifically supplied control command (that is to say for example certain parameters of a transfer algorithm defined by parameters are changed), whereas external operating parameters pe may be used as further input variables of the transfer algorithm, that is to say the transfer strategy makes provision for the energy transfer unit 40 to additionally be controlled as a function of supplied external operating parameters pe.

In the example, the external operating parameters pe include for example a current power demand and also a predicted future power demand, for example based on data obtained from a navigation system of the vehicle containing information, which affects the energy or power demand of the vehicle, about a current road (for example incline, gradient, curves, traffic lights, etc.) and/or information that is comparable (but still relevant in the future) about characteristics of a route defined in the navigation system.

In the present application scenario, in order to supply electrical energy to an electric drive system of a vehicle, it is usually provided for an energy storage capacity of the second storage unit 30 (HEC storage unit) to be substantially greater than an energy storage capacity of the first storage unit 20 (HPC storage unit). By way of example, these capacities may differ from one another at least by a factor of 5, or for example at least by a factor of 10.

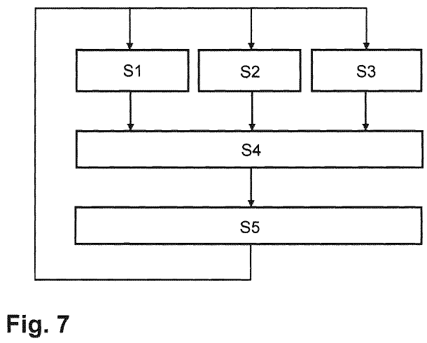

FIG. 7 shows a schematic flowchart of the operating method carried out by way of the control device 70 of the energy storage system 10.

In a step S1, the charge states (for example “SoC”) soc-p, soc-e of the high-power cells (HPC) 22 and high-energy cells (HEC) 32 are recorded by way of the sensor systems 60, 62 in the storage units 20, 30 of the electrical energy storage device and communicated to the control device 70 of the energy storage system 10. In one embodiment, in this case, at least for the high-energy cells 32 (HPC), their power state (for example “SoP”) is also recorded and communicated to the control device 70 as an additional operating parameter of the electrical energy storage device (20, 30).

In steps S2 and S3, which are carried out in parallel with step S1 by the control device 70, one or more control commands cs are (optionally) received in step S2 if such control commands cs are output by the external control device 3 of the vehicle to the energy storage system 10 and, in step S3, one or more external operating parameters pe output by the external control device 3 of the vehicle to the control device 70 are received.

In a step S4, the control device 70 executes a transfer algorithm implemented by software stored therein in order to transfer energy as required between the first storage unit 20 and the second storage unit 30 in accordance with a transfer strategy as a function of at least the recorded charge states soc-p, soc-e (and, for example, additionally power state at least of the high-power cells 22, possibly also high-energy cells 32) and the one or more received external operating parameters, for which purpose the control device 70 generates a suitable control signal ct based on a corresponding specification of setpoint value ranges for the charge states soc-p, soc-e and communicates same to the energy transfer unit 40.

If a control command cs was received in step S2, then the transfer strategy is thus modified accordingly in step S4, that is to say for example a modified dependency of the energy transfer or setpoint value ranges on the recorded operating parameters and the (externally transmitted) operating parameters is used.

In a step S5, the energy transfer between the storage units 20, 30 is carried out by the energy transfer unit 40 as a function of the control signal ct. Provision is made in step S5 for a time-modulated current IE to flow through the connection 34 of the second storage unit 30 in order to charge or discharge the high-energy cells 32 through appropriate control of the energy transfer unit 40.

The processing then returns to steps S1 to S3, which are executed in parallel.

In step S2, for example, a control command may be received, commanding the transfer of a certain amount of electric charge (or electrical energy) from one of the storage units 20, 30 to the other of these storage units 20, 30. Such a command may be generated by a device of the vehicle electronics (for example a program-controlled central controller), for example based on a predicted future (more or less imminent) power demand. The prediction may be based here for example on an evaluation of data that have been obtained from a navigation system of the vehicle, be these for example regarding a current road and/or for example regarding a route specified by a user in the navigation system. As an alternative to this example, external operating parameters (for example data from navigation system) could also be evaluated internally, that is to say by the control device 70 of the energy storage system 10, and the transfer strategy could make provision for the evaluation result to be jointly considered accordingly. Another example of a control command is a command to permanently modify the transfer strategy (comparable to an “update” of the software running in the controller 70), for example based on data from a fleet manager of a multiplicity of vehicles.

In step S3, a speed of the vehicle may be transmitted to the control device as an external operating parameter, for example, wherein, in step S4, provision may then be made for example for a specification of setpoint values or setpoint value ranges for the charge states that is dependent on this speed. One example in this regard: As long as the vehicle is stationary (for example in a traffic jam) or is driving very slowly, there is no noteworthy possibility of recuperating braking energy. In this operating state of the vehicle, it may therefore be expedient to tend to increase a portion of stored total energy stored in the HPC storage unit (for example in comparison to an operating state with a speed of the vehicle in a medium range). The supplying of the external operating parameter “vehicle speed” and/or further external operating parameters characterizing the operating state of the vehicle allows the control device 70 to make such optimizations to the transfer strategy. In this context, it should be noted that, in contrast to this example, an external operating parameter (for example vehicle speed) could also be evaluated externally, for example by the abovementioned vehicle electronics, and control commands cs could be generated based thereon and transmitted (in step S2).

In step S4, the transfer strategy might not only determine (as part of the setpoint value or setpoint range specification of the charge states soc-p, soc-e) whether or when electric charge (or energy) should be transferred from one of the storage units 20, 30 to the other. In one embodiment, provision is instead made for the transfer strategy also to be determined through a specification of the abovementioned modulation parameters, using which “current profile” (characteristics of the time-modulated current IE) the energy transfer is brought about. All parameters able to be used here to influence the setpoint value/range specification may alternatively or additionally be used to specify or change one or more modulation parameters as part of the transfer strategy. One example in this regard: If it is able to be discovered (for example using AI), from data from a fleet manager of a multiplicity of vehicles, that the performance and/or service life of the energy storage system (or of the individual storage units 20, 30) depends on a certain setting or change of the modulation parameters, possibly also on operating parameters (internal and/or external), then a corresponding command to modify the transfer strategy may be transmitted to the controller 70.

The description of the invention is merely exemplary in nature and, thus, variations that do not depart from the gist of the invention are intended to be within the scope of the invention. Such variations are not to be regarded as a departure from the spirit and scope of the invention.

List of reference signs

| | |
|---|---|
| 1 | Electric drive system |
| 2 | Inverter |
| 3 | Control device (of the vehicle) |
| 4 | Electric drive machine |
| 5 | Vehicle wheels |
| 6 | Charging connection |
| 7 | Charging electronics |
| 10 | Energy storage system |
| 20 | First storage unit (HPC) |
| 22 | High-power cells |
| 24 | First connection |
| 30 | Second storage unit (HEC) |
| 32 | High-energy cells |
| 34 | Second connection |
| 40 | Energy transfer unit |
| 50 | Connection device |
| 60 | Sensor system (for first storage unit) |
| 62 | Sensor system (for second storage unit) |
| 64 | Sensor system (current measurement) |
| 70 | Control device |
| IP | Charge/discharge current (first storage unit) |
| IE | Charge/discharge current (second storage unit) |
| t | Time |
| T1 | Pulse time (for pulse current component) |
| T2 | Pulse pause time (for pulse current component) |
| TP | Period (for pulse current component) |
| t1 | Pulse time (for ripple current component) |
| t2 | Pulse pause time (for ripple current component) |
| tp | Period (for ripple current component) |
| IL | Charge/discharge current (load current of the energy storage device) |
| il | Measured value for charge/discharge current |
| soc-p | Measured value for charge state (first storage unit) |
| soc-e | Measured value for charge state (second storage unit) |
| ci | Control signal (for inverter) |
| ct | Control signal (for energy transfer unit) |
| cs | Control signal (for control device) |
| pe | Control signal (data relating to external operating parameters) |

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An energy storage system, comprising:
an electrical energy storage device further comprising:
a first storage unit consisting of high-power cells and a first connection for charging and discharging the high-power cells;
a second storage unit consisting of high-energy cells and a second connection for charging and discharging the high-energy cells;
a controllable bidirectional energy transfer unit, connected to the first connection and to the second connection in order to enable energy to be transferred between the first storage unit and the second storage unit;
a connection device connected to the first connection and intended to charge and discharge the electrical energy storage device;
a recording device for recording operating parameters of the electrical energy storage device, the operating parameters further comprising:
at least one state parameter of the high-power cells;
at least one state parameter of the high-energy cells;
a control device for controlling the energy transfer unit in accordance with a transfer algorithm that makes provision to control the energy transfer unit in accordance with a transfer strategy as a function of the recorded operating parameters;
wherein the transfer strategy provides a specification of setpoint values or setpoint value ranges for a charge state of the high-power cells and a charge state of the high-energy cells.

15. The energy storage system of claim 1, wherein the energy transfer unit is able to be controlled by way of the control device so as to achieve a transfer of energy in which a time-modulated current flows through the second connection in order to charge and/or discharge the high-energy cells.

16. The energy storage system of claim 2, the transfer strategy further comprising:
a specification of one or more modulation parameters for the time-modulated current;
wherein this specification of the modulation parameters is provided as a function of the recorded operating parameters.

17. The energy storage system of claim 2, wherein the time-modulated current has a pulse current component and/or a ripple current component.

18. The energy storage system of claim 1, further comprising:
a data interface via which an external device is able to supply, to the control device:
control commands, wherein the transfer strategy is modified as a function of supplied control commands; and/or
external operating parameters, wherein the transfer strategy also makes provision to control the energy transfer unit as a function of supplied external operating parameters.

19. The energy storage system of claim 5, the external operating parameters further comprising a current power demand and/or a predicted future power demand.

20. The energy storage system of claim 1, wherein the first storage unit and/or the second storage unit each have multiple subunits that are able to be operated separately from one another and that are each formed from an associated portion of the high-power cells or high-energy cells of the storage unit in question.

21. The energy storage system of claim 7, wherein the controllable bidirectional energy transfer unit, in conjunction with the first and second connections, is designed, during the transfer of energy between the first storage unit and the second storage unit, to enable a dissipation or supply of a respective partial energy that is defined in each case individually by the control device for the multiple subunits.

22. The energy storage system of claim 1, the electrical energy storage device further comprising an energy storage capacity of at least 20 kWh.

23. The energy storage system of claim 1, the electrical energy storage device further comprising an energy storage capacity of at least 40 kWh.

24. The use of an energy storage system of claim 1 for supplying electrical energy to an electric drive system of a vehicle.

25. The use of an energy storage system of claim 1, for supplying electrical energy to a power supply grid for consumers able to be connected thereto.

26. A method for operating an energy storage system of claim 1, comprising the steps of:
recording operating parameters of an electrical energy storage device of the energy storage system, the operating parameters further comprising:
a state parameter of high-power cells of a first storage unit of the electrical energy storage device; and
a state parameter of high-energy cells of a second storage unit of the electrical energy storage device;
executing a transfer algorithm that makes provision to transfer energy between the first storage unit and the second storage unit in accordance with a transfer strategy as a function of the recorded operating parameters, wherein the transfer strategy provides a specification of setpoint values or setpoint value ranges for a charge state of the high-power cells and a charge state of the high-energy cells.

27. The method of claim 13, further comprising the steps of, in accordance with the transfer algorithm, controlling a transfer of energy in which a time-modulated current flows through a connection of the second storage unit in order to charge and/or discharge the high-energy cells.

28. The method of claim 13, further comprising the steps of:
receiving control commands to modify the transfer strategy as a function of received control commands;
receiving external operating parameters for controlling the transfer of energy also as a function of received external operating parameters.

29. The method of claim 13, for supplying electrical energy to an electric drive system of a vehicle.

30. The method of claim 13, for supplying electrical energy to a power supply grid for consumers able to be connected thereto.
